(19) United States
(12) Patent Application Publication
(10) Pub. No.: US 2025/0284554 A1
(43) Pub. Date: Sep. 11, 2025

(54) SYSTEM AND METHOD OF PROVIDING A CLOUD-SERVICE PROVIDER EXCHANGE

(71) Applicant: Adaptive Computing Enterprises, Inc., Naples, FL (US)

(72) Inventor: Arthur L. ALLEN, Naples, FL (US)

(21) Appl. No.: 18/628,990

(22) Filed: Apr. 8, 2024

Related U.S. Application Data
(63) Continuation-in-part of application No. 18/596,820, filed on Mar. 6, 2024.

(51) Int. Cl. G06F 9/50; G06Q 30/0283; G06Q 30/0601

(52) U.S. Cl. CPC G06F 9/5072; G06Q 30/0283; G06Q 30/0641

(57) ABSTRACT

A system for operating a compute exchange includes at least one processor; and a computer-readable storage device storing instructions which, when executed by the at least one processor, cause the at least one processor to be configured to: receive, at the compute exchange, a request from a user for workload to be processed in a computing environment; obtain a price for processing the workload in one of a plurality of cloud service providers; receive, at the compute exchange, respective real-time pricing from respective cloud service providers for processing the workload; determine, at the compute exchange, a chosen cloud service provider based on the respective real-time pricing; and cause a portion of the workload to be processed on the chosen cloud service provider.

### CROSS-REFERENCE TO RELATED APPLICATIONS

The present application is a continuation-in-part of U.S. patent application Ser. No. 18/596,820, filed Mar. 6, 2024, Docket No. 174-0104, the contents of which is incorporated herein by reference.

The present application is related to U.S. application Ser. No. 17/545,149, filed on Dec. 8, 2021, the contents of which are incorporated herein by reference. The present application is related to U.S. application Ser. No. 18/596,705 (Docket No. 174-0101A), U.S. application Ser. No. 18/596,718 (Docket No. 174-0101B), U.S. application Ser. No. 18/596,734 (Docket No. 174-0102), and U.S. application Ser. No. 18/596,775 (Docket No. 174-0103), all filed on Mar. 6, 2024, the contents of which are incorporated herein by reference.

### FIELD OF THE INVENTION

The present application relates to providing a multi-cloud-compute-exchange in which users could submit workload to the exchange and receive real-time pricing and accessibility to multiple cloud/infrastructure providers and then submit the workload for processing in the most cost-effective cloud/infrastructure provider, which could include the use of local on-premises compute resources.

### BACKGROUND

Accessing cloud service providers such as (Oracle Cloud Infrastructure), AWS (Amazon Web Services), Google Cloud, Azure, OTC (Open Telekom Cloud), Alibaba, high performance computing (HPC) CloudMart, VMware, and/or OpenStack can be challenging. Users must proceed through a complicated user interface to select the service provider, identify or configure the compute resources and get the compute resources deployed so that they can utilize them.

Users typically will need to create an account at the various cloud service providers and if they desire to select one with the best pricing or availability, they must go into each account separately and use a console, command line interface, or other software development kid to create and configure the resources that they need.

### BRIEF SUMMARY

There are inefficiencies in the process described above.

The present disclosure introduces a compute exchange in which users can access the compute exchange to provide their workload that requires compute resources. The compute exchange can be in communication with a plurality of cloud service providers and can receive real-time pricing data for each respective cloud service provider. Users can provide pricing as an “ask” in the context of a bid-ask framework similar to the stock market. The respective cloud service providers can provide the real time pricing data or respond to access the asking price and from the compute exchange, a chosen cloud service provider can be selected and the workload can then flow to the chosen cloud service provider for processing.

In some aspects, the techniques described herein relate to a method including: receiving, at a compute exchange, a buy order from a compute resource buyer of a plurality of compute resource buyers to purchase compute resources to process workload; receiving, at the compute exchange, a sell order from one or more compute resource seller from a plurality of compute resource sellers; matching, at the compute exchange, the buy order from the compute resource buyer with the sell order from the one or more compute resource seller to identify a chosen compute resource seller at a price; and initiating, by the compute exchange, a process to enable a portion of the workload from the compute resource buyer to be processed by the compute resources from the chosen compute resource seller at the price.

In some aspects, the techniques described herein relate to a system for operating a compute exchange, the system including: at least one processor; and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.

In some aspects, the techniques described herein relate to a computer-readable storage device storing instructions which, when executed by at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.

In some aspects, the techniques described herein relate to a compute exchange including: means for receiving, at a compute exchange, a buy order from a compute resource buyer of a plurality of compute resource buyers to purchase compute resources to process workload; means for receiving, at the compute exchange, a sell order from one or more compute resource seller from a plurality of compute resource sellers; means for matching, at the compute exchange, the buy order from the compute resource buyer with the sell order from the one or more compute resource seller to identify a chosen compute resource seller at a price; and means for initiating, from the compute exchange, a process to enable a portion of the workload from the compute resource buyer to be processed by the compute resources from the chosen compute resource seller at the price.

In some aspects, the techniques described herein relate to a method including: transmitting, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmitting a portion of the workload from the compute resource buyer to the chosen compute resource seller for processing on the purchased compute resources; and receiving a result from processing the workload on the purchased compute resources of the chosen compute resource seller.

In some aspects, the techniques described herein relate to a system including: at least one processor; and a computer-readable storage device storing instructions which, when executed by the at least one processor, cause the at least one processor to be configured to: transmit, from the system and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.

In some aspects, the techniques described herein relate to a system including: means for transmitting, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; means for transmitting a portion of the workload from the compute resource buyer to the chosen compute resource seller for processing on the purchased compute resources; and means for receiving a result from processing the workload on the purchased compute resources of the chosen compute resource seller.

In some aspects, the techniques described herein relate to a computer-readable storage device storing instructions which, when executed by at least one processor, cause the at least one processor to be configured to: transmit, from a compute resource buyer and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.

In some aspects, the techniques described herein relate to a method including: transmitting, from a compute resource seller of a group of compute resource sellers including one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receiving a portion of the workload from the chosen compute resource buyer at the compute resource seller for processing on the purchased compute resources; and transmitting a result from processing the workload on the purchased compute resources of the chosen compute resource buyer.

In some aspects, the techniques described herein relate to a system including: at least one processor; and a computer-readable storage device storing instructions which, when executed by the at least one processor, cause the at least one processor to be configured to: transmit, from the system which includes a compute resource seller of a group of compute resources sellers including one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.

In some aspects, the techniques described herein relate to a system including: means for transmitting, from a compute resource seller of a group of compute resources sellers including one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; means for receiving a portion of the workload from the chosen compute resource buyer at the compute resource seller for processing on the purchased compute resources; and means for transmitting a result from processing the workload on the purchased compute resources of the chosen compute resource buyer.

In some aspects, the techniques described herein relate to a computer-readable storage device storing instructions which, when executed by at least one processor, cause the at least one processor to be configured to: transmit, from a compute resource seller of a group of compute resources sellers including one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.

In some aspects, a compute exchange can be used to sell future use of compute resources. A method in this regard can include receiving, at a compute exchange, a buy order from a compute resource buyer of a plurality of compute resource buyers to purchase compute resources to process workload; receiving, at the compute exchange and at a first time, a sell order from a compute resource seller to sell compute resources at a future time relative to the first time; matching, at the compute exchange, the buy order from the compute resource buyer with the sell order from the compute resource seller to yield a transaction; and causing the transaction to be recorded. The method can include, when the future time becomes a current time, initiating, by the compute exchange, a process to enable a portion of the workload from the compute resource buyer to be processed by the compute resources from the compute resource seller at a price. The method can further include causing the transaction to be recorded on a blockchain network comprising a plurality of distributed nodes operating a distributed ledger and consensus algorithm, wherein a block is added to a blockchain of the blockchain network to record the transaction in an immutable manner.

In some aspects, a system can include at least one processor; and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.

In some aspects, a system can include one or more: means for receiving, at a compute exchange, a buy order from a compute resource buyer of a plurality of compute resource buyers to purchase compute resources to process workload; means for receiving, at the compute exchange and at a first time, a sell order from a compute resource seller to sell compute resources at a future time relative to the first time; means for matching, at the compute exchange, the buy order from the compute resource buyer with the sell order from the compute resource seller to yield a transaction; and means for causing the transaction to be recorded.

In some aspects, a computer-readable storage device stores instructions which, when executed by at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of a compute exchange, according to some aspects of this disclosure;

FIG. 2 illustrates a block diagram of various deployment models which can be used in connection with a compute exchange, according to some aspects of this disclosure;

FIG. 3 illustrates a block diagram of a compute exchange used to enable compute buyers and compute providers to buy and sell access to compute resources, according to some aspects of this disclosure;

FIG. 4A illustrates an example method embodiment related to a compute exchange, according to some aspects of this disclosure;

FIG. 4B illustrates an example method embodiment related to a compute resource buyer, according to some aspects of this disclosure;

FIG. 4C illustrates an illustrates an example method embodiment related to a compute resource seller, according to some aspects of this disclosure;

FIG. 4D illustrates an illustrates an example method embodiment related to a compute resource exchange for future use of compute resources, according to some aspects of this disclosure;

FIG. 5 illustrates a method embodiment from the standpoint of a cloud service provider, according to some aspects of this disclosure;

FIG. 6 illustrates a method embodiment from the standpoint of a cloud service provider, according to some aspects of this disclosure; and

FIG. 7 illustrates a system according to some aspects of this disclosure.

### DETAILED DESCRIPTION

As noted above, the current state of accessing cloud service providers is inefficient and can be expensive. There is no mechanism that enables users to compare pricing for their workloads across different providers.

This disclosure introduces a compute exchange that can enable users through one interface to submit workload or workload requests and obtain real-time pricing data from a plurality of cloud service providers and enables the user or the compute exchange to pick a chosen cloud service provider and then facilitate the deployment of compute resources by the chosen cloud service provider for processing the workload.

Note that compute resources can include one or more of a software application, an artificial intelligence application, a machine learning application, hardware, bandwidth, communication pathways, blockchain-based services and virtual compute resources. While the examples provided herein are generally related to hardware such as access to computer processors, memory and so forth, the broader application includes other aspects such as software applications or services as well.

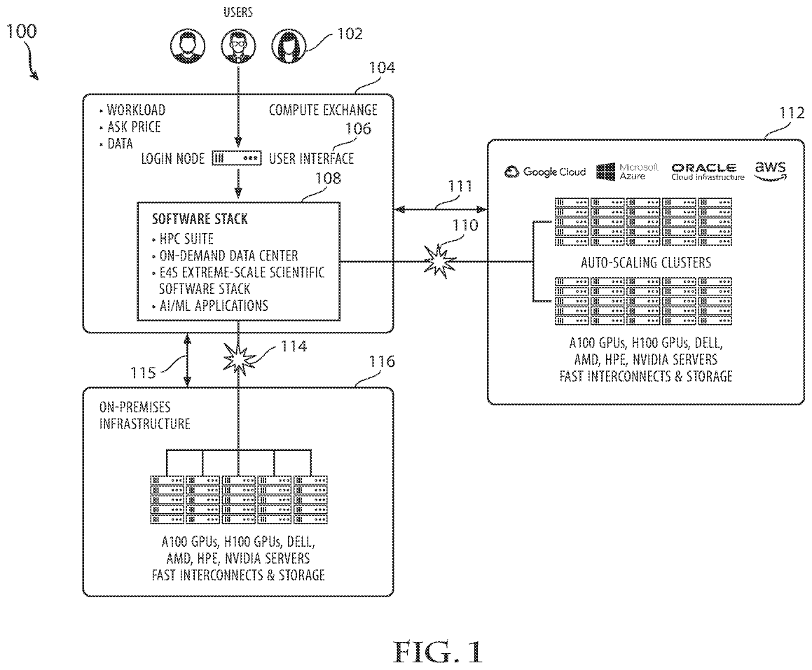

FIG. 1 illustrates a cloud service provider network 100 that can include features such as a set of users 102 that access a compute exchange interface 104 that provides a user interface 106 for the users 102 to be able to access compute resources in one or more compute environments such as an on-premises infrastructure 116 and/or a cloudmart (which is also labeled as a compute exchange) 112 which can provide compute resources from a plurality of cloud service providers such as Google Cloud, Microsoft Azure, Oracle Cloud Infrastructure and Amazon Web Services (AWS). Any other cloud service providers can be included as well. The compute exchange 204 can receive various items from the users. For example, users 102 can, via a graphical user interface or a command line, provide workload, request for processing workload, other data such as characteristics of the workload, parameters or quality of service requirements (i.e., timing, number of nodes/cores, time to start, time to finish, etc.) and so forth. The users 102 may also provide a price for the compute resources to process their workload. The price can be the maximum amount the user 102 is willing to pay for the compute resources to process their workload. The price can be characterized as a bid price from the buyer or the user 102.

The cloudmart 112 can include compute resources such as, by way of example, A100 GPUs (graphical processing units), H100 GPUS, Dell, AMD (Advanced Micro Devices), HPE (Hewlett Packard Enterprise), NVIDIA Servers, Fast interconnects and storage components. The ability to auto-scale up clusters is included in the cloudmart 112.

The “compute exchange” can represent any one or more of the components disclosed in FIG. 1 including the compute exchange interface 104, the cloudmart 112 and/or the on-premises infrastructure 116.

The compute exchange interface 104 can include a variety of software components 108 to make the exchange work. These can include one or more of a high-performance computing suite (such as the Moab HPC Suite from Adaptive Computing), an on-demand data center, E4S extreme-scale scientific software stack and/or applications such as artificial intelligence or machine learning applications. The E4S extreme-scale scientific software stack is a community effort to provide open source software packages for developing, deploying and running scientific applications on HPC and AI platforms. The compute exchange interface 104 can be in communication via a communication channel 111 with the cloudmart 112. The cloudmart 112 can include the plurality of cloud service providers which can determine real time asking prices for their compute resources. For example, via the communication channel 111, each respective cloud service provider can provide real-timing pricing information for their compute resources. The real-time pricing can be based on a number of factors such as the demand for the compute resources for that particular cloud service provider, the supply of compute resources, the timing of the need for resources such as immediately or at a future scheduled time, or for a range of times, the type of hardware or virtual compute resources that are available, and so forth.

In some aspects, the “compute exchange” can be defined as one or more of the software and hardware components of compute exchange interface 104, plus the various software and hardware components of the cloudmart 112 and/or the on-premises infrastructure 116. All of these components may be considered the compute exchange as they include the management and user interface aspects of the compute exchange interface 104 plus the use of compute resources from the cloudmart 112 and/or the on-premises infrastructure 116.

The compute exchange interface 104 can also be in communication with an on-premises infrastructure 116 that can include compute resources such as, by way of example, A100 GPUs (graphical processing units), H100 GPUS, Dell, AMD (Advanced Micro Devices), HPE (Hewlett Packard Enterprise), NVIDIA Servers, Fast interconnects and storage components.

Status data about the on-premises infrastructure 116 can be provided to the compute exchange interface 104 through a communication link 115. The status data can be real-time and be related to the availability of compute resources within the on-premises infrastructure 116. In this regard, the compute exchange interface 104 can utilize knowledge about the availability of compute resources in the on-premises infrastructure 116 when making decisions regarding where to process workload received by users 102.

For example, the compute exchange interface 104 may get a request for processing workload from a user and a bid price of $100. The data received from the cloud service providers might indicate that the best offer for that workload (given its characteristics, quality of service requirements, etc.) might be $115 from AWS. In some aspects, the user can be given the opportunity to accept the pricing of AWS at $115 and commit the workload to be processed by AWS. Then the workload can be burst 110 into AWS as the cloud service provider for processing. The compute exchange interface 104 can provide all the necessary instructions for deployment, processing, and destroying or tearing down deployed compute nodes or clusters in the cloud service provider. Furthermore, there is no restriction on the workload being services by a single cloud service provider. The workload may be divided into portions that can be processed in difference compute environments between the on-premises infrastructure 116 and one or more cloud service providers.

In another aspect, perhaps there is sufficient compute resources in the on-premises infrastructure 116 and because the offer from AWS was more than the bid price of $100, then compute exchange interface 104 can burst 114 the workload into the on-premises infrastructure 116 or may just process the workload on the on-premises infrastructure 116. As noted above, the workload may also be divided between the on-premises infrastructure 116 and one or more cloud service provider. The division may be based on price, a characteristic of the compute resources, a timing of when compute resources are available, and so forth. The division may also be based on time where a first portion of the workload may be processed at a current time or at a first future time and a second portion is processed at a second future time. The division here can be in this manner because the “thing” that is sold on the exchange are compute resources for a certain period of time or for use at a certain time. After the compute resources are used the “thing” sold no longer exists.

The workload may be divided also by portions that have different processing characteristics (high data intensive versus high processing requirements) and two or three or more different portions could be processed by different compute environments. In this manner, users can efficiently obtain compute resources at the best price or under the best circumstances even if it is not the best price. For example, users might be willing to pay more than a bid price for compute resources that are available sooner or that are of higher quality or that provide a better guarantee.

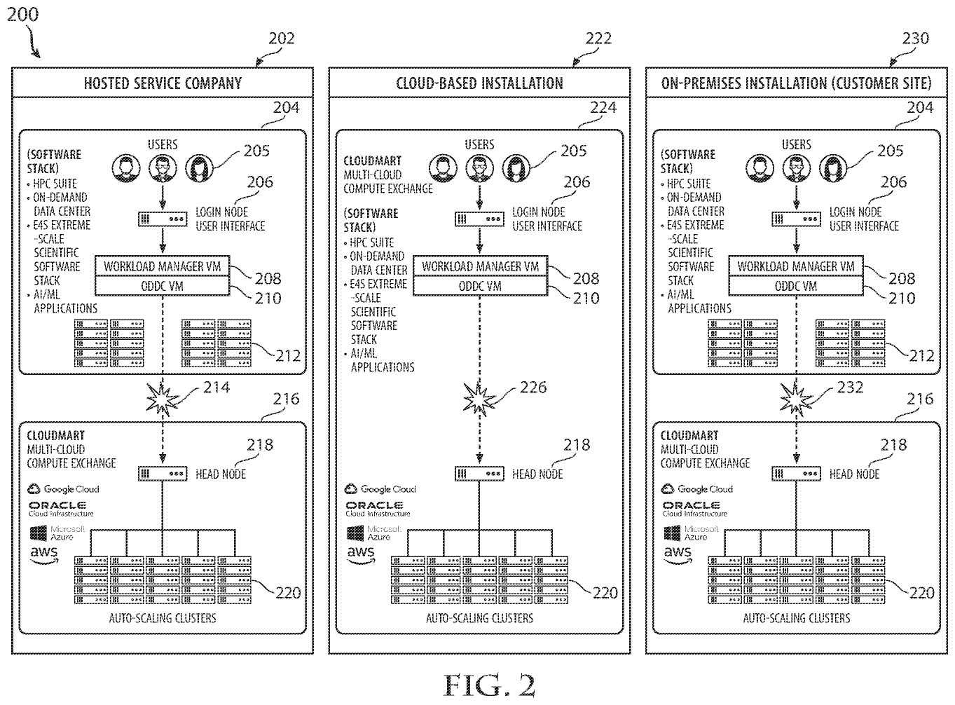

FIG. 2 illustrates an example of various deployment models 200. FIG. 2 shows various configurations which can all be used in the context of where or how a compute exchange interface 104 can be configured or located. In a first aspect, the compute exchange can be configured or hosted at a service company which can be independent of any cloud service providers but may not directly be on-premises with a company having workload to process. In FIG. 2, a system 204 can include features or software modules or a software stack which can include an HPC Suite, an on-demand data center (ODDC) module, and E4S extreme-scale scientific software stake and applications such as AI/ML applications. Hardware nodes 212, a workload manager (which can be configured with a virtual machine) 208 and an ODDC virtual machine 210 can also be provided with a long node/user interface 206 for users 205 to interaction with the system 204. Here, the system 204 can also operate as a compute exchange to enable the bid/ask process to occur so that workload can be burst 214 into a cloudmart 216 which can include a head node 218 and auto-scaling clusters 220 with various cloud service providers. In some aspects, the “compute exchange” can include the system 204 and/or the cloudmart 216.

FIG. 2 also illustrates a cloud-based installation 222 in which a cloud mart or muti-cloud compute exchange 224 is installed at a cloud service provider along with a login node user interface 206 for users and a workload manager 208 and ODDC 210 with the various software stake included. Then, the “bursting” 226 can essentially be achieved all within a cloud service provider with a head node 218 and auto-scaling clusters 220.

FIG. 2 further discloses an on-premises installation 230 in which a system 204 is configured on within an on-premises compute environment and can include features or software modules or a software stack which can include an HPC Suite, an on-demand data center (ODDC) module, and E4S extreme-scale scientific software stake and applications such as AI/ML applications. Hardware nodes 212, a workload manager (which can be configured with a virtual machine) 208 and an ODDC virtual machine 210 can also be provided with a long node/user interface 206 for users 205 to interaction with the system 204. Here, the system 204 can also operate as a compute exchange to enable the bid/ask process to occur so that workload can be burst 232 into a cloudmart 216 which can include a head node 218 and auto-scaling clusters 220 with various cloud service providers. In some aspects, the “compute exchange” can include the system 204 and/or the cloudmart 216.

The formal definition of what constitutes the “compute exchange” can include any one or more of the components shown in FIG. 1 or 2.

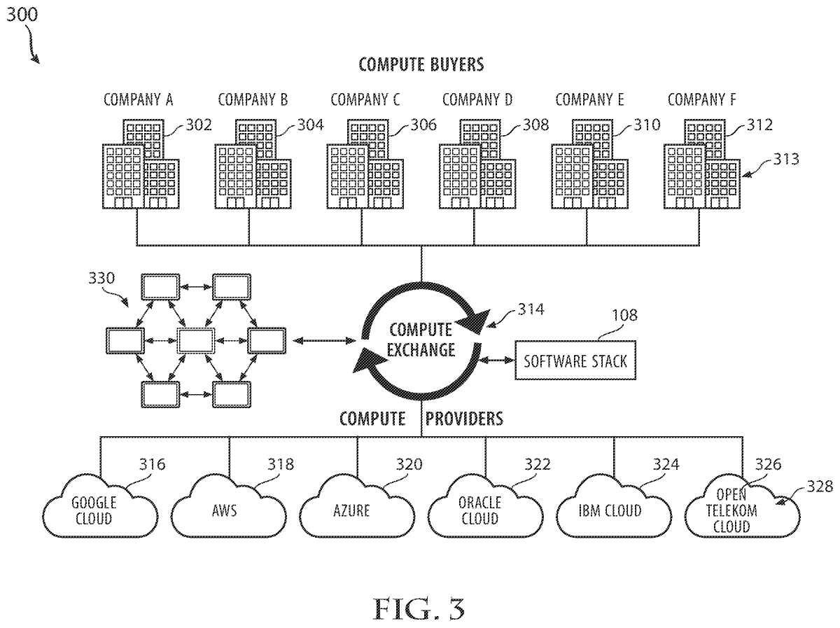

FIG. 3 illustrates an example compute market exchange 300 including a group of compute resources buyers 313, the compute exchange 314 and a group of compute resource providers 328. The group of compute resources buyers 313 can include companies A(302), B(304), C (306), D (308), E (310), F (312). The compute exchange 314 can be similar to the other compute exchanges disclosed herein. In some examples, the compute exchange 314 can include or be connected to a software stack 108 similar to that shown in FIG. 1 with the various tools to handle workload and the transfer of workload to a cloud computing provider.

The group of compute providers 328 can include by way of example Google Cloud 316, AWS 318, Azure 320, Oracle Cloud 322, IBM cloud 324, and Open Telekom Cloud 326. These are just example cloud computing sellers or various cloud providers. In a standard exchange, companies wanting to raise capital are registered with accounts at a stock exchange and offers ownership shares by going public and listing its shares on the stock exchange. Examples of stock exchanges include the New York Stock Exchange (NYSE), NASDAQ, London Stock Exchange (LSE), etc. Typically, buyers and sellers participate in the stock exchange. Individuals, institutional investors (such as mutual funds, pension funds, hedge funds), and even other companies can buy and sell shares of these listed companies. These buyers and sellers are constantly interacting in the stock market. In the present example, rather than a stock exchange, compute resources are offered for sale by sellers and buyers buy those compute resources, rather than from a fixed price but from an exchange in which, like stock, the price can vary depending on demand or other factors. The compute resources have value in the sense they are available for use at a current time or a future time. The timing of when they are available can impact the price. For example, a buyer may need compute resources now which might cost more. The buyer may seek compute resources a week from now or within a window of time starting three days from now which may cause the resources to be cheaper because the compute providers can adjust or reserve those resources for the buyer in advance.

Buyers and sellers typically place orders through brokerage firms for stock purchases. There are two main types of orders: market orders and limit orders. A market order is an instruction to buy or sell a stock at the current market price. A limit order is an instruction to buy or sell a stock at a specified price or better. In the present new application, buyers and sellers place orders through the compute exchange 314 for the sale of or purchase of compute resources. The orders on either side of the transactions can also be market orders or limit orders as well. The orders however are not for stock but for the use of compute resources.

Typically, with stock, the price is the same for each share of stock that is for sale. However, with compute resources, a compute resource seller might have a large amount of compute resources available for use. For example, there may be 1000 nodes available for a certain day or for a certain amount of time. Rather than a fixed or similar price, the seller can offer a cheaper price on a per node/per hour basis. If the compute resources were stocks, in other words, and one share was comparable to one node for one hour, the difference is that the seller may offer groups of “shares” such as 1000 nodes for 4 hours at a discounted price for potential compute resource buyers. The pricing and demand of compute resources can cause the decisions to be made to be fundamentally different than stock valuations and pricing.

The compute exchange 314 can match orders electronically by the exchange's trading platform. When a buyer's bid price matches a seller's ask price, a trade occurs for the compute resources. The process can be facilitated by the exchange's order book, which keeps track of all buy and sell orders. Note that the result in this case is not ownership of a stock however but rather is the right to access compute resources. The compute exchange 314 differs from a normal stock exchange in that is either includes or is connected to a software stack 108 that enables the actual transfer of workload from the compute resources buyer to the chosen compute resource seller for the use of the purchased or chosen compute resources. Further, the compute resources can be for future use and can also include software components or applications as well as part of the compute resources. For example, a seller can sell 10 nodes and an artificial intelligence engine as a package.

The price at which trades occur is determined by supply and demand of the compute resources, a time of their offering, how long they can be used, and other features of the offer such as software packages to include with the compute resources, and can also be based on other factors such as bulk compute resources and/or timing of available resources. If more people want to buy compute resources (demand) than sell the compute resources (supply), the price will typically rise. Conversely, if more people want to sell than buy, the price will fall. This continuous interaction of supply and demand sets the price of the compute resources in real-time.

Other factors with respect to the price of compute resources that also differs from stock is that the compute resources may not be immediately available. Some compute resource providers may desire to sell access to compute resources in two days where they have an opening in reservations for their compute resources. Compute resource buyers may see not just offers for sale of compute resources but also a timing component of when those compute resources are available for use. Cheaper compute resources may be sold when there is a timing restriction on when they can be used.

In some stock markets, there are entities known as market makers or specialists who facilitate trading by providing liquidity. They do this by continuously buying and selling shares to ensure there's always a market for a particular stock. In the application disclosed herein, market makers or specialists may continuously buy and sell compute resources to ensure that there is always a market for a particular compute resource.

Note that each computer resource seller of the group of compute providers 328 may “sell” different types of compute resources as well with individual pricing. A computer resource seller may have different types of compute resources such as compute resources of quality A (e.g., newer more efficient processors), quality B (e.g., two year old computer processors), quality C (e.g., 6 year old computer processors), as well as different types or quality of memories, bandwidth, as well as software packages or stacks that may be included as well, and so forth. The compute resources might for sale for use in two weeks or for use in three days but are available for use for a block of 10 yours. Thus, the sale of compute resources may include a description of the type or quality of resources, timing, software included, etc., that are offered. Buyers may in order may make bids for compute resources and may include a requirement that the compute resources be of a certain threshold of quality (e.g., quality B or above), or include certain software packages, or are available immediately or at certain times for a certain amount of time. Further, some buyers may know that they will need compute resources beyond their on-premises compute resources in a week. The buyer can then enter an order for compute resources at a certain time (in one week from today). The buy may be able to target a specific time at which workload needs to be processed. Thus, the sale transaction for the compute resources at the certain time which can then be established as a reservation by the software sock 108 to enable the workload to be transferred to the compute resources of the chosen compute resource seller.

The software stack 108 can include software components or applications that can be used to help execute workload as well. Thus, the compute exchange 314 may not only include the purchase of compute resources but could also include offers and bids that include software applications are any feature “as a service” that could be sold through the compute exchange 314. For example, an offering of compute resources from AWS 318 could include not only hardware components but also an artificial intelligence engine or accounting software for example. The offering could include access to a premium version of ChatGPT as part of the use of the compute resources. The offering could also simply include access to applications themselves and the underlying compute resources would automatically be included. For example, the use of compute resources might include output that is to be submitted to ChatGPT for obtaining a result from generative AI. That result may then need to be further processed. Thus, the “compute resources” may include processing as well as interactions with other systems (which may cost money) and further processing of results. The “compute resources” may in this regard include interactions or use of smart contracts and use of or interactions with blockchain networks as well.

In some aspects, the compute resources may be immediately available and thus up for sale. The actual use of the compute resources can be implemented after the transaction is complete and the compute buyer can then access the compute resources for workload and also access any applications or other features that were included as part of the purchased compute resources. In one compute resources in some sense are not like stocks where one does not buy the compute resources from the compute exchange 314 for hoping they go up in value and then sell them for a profit on the compute exchange 314. However, such a scenario is possible where compute providers 328 can offer compute resources for sale for use at a future date. For example, a compute provider like Google Cloud 316 may have reservations into the future for the use of their compute resources but may see a gap of reserved use weeks out and offer those compute resources at that time for sale. Note that compute resources in this regarding include not only use of the compute resources but also the time frame of their use. The compute resource is basically access to the compute resource but also at a specific time in some cases. Thus, a company such as company A 302 may bid on and purchase the use of certain compute resources in two weeks (at a discounted price). As time goes on, they may realize they don't need those compute resources. In some aspects, a ledger or order book can track that they “own” those compute resources at the future time. A blockchain network 330 can be used to record that transaction and confirm that they are the owners of the use of the compute resources at the future time. For example, they may have a minted non-fungible token (NFT) or other software component or key that can be used to confirm “ownership” and thus access those compute resources to be used in the future.

The blockchain network 330 has certain characteristics such as it includes a plurality of distributed nodes each having an instance of a consensus algorithm and an instance of a distributed ledger. When a transaction is to be recorded, the consensus algorithm “agrees” to the transaction meaning that a threshold number of nodes each operating their instance of the consensus algorithm approve of the transaction, and then it is added as part of a new block to the blockchain. Thus, the operation of a blockchain network is different from operations just on a generic computer. A blockchain network operates on the principles of decentralization, immutability, and consensus. The basic operation of the blockchain network 330 include the concept of decentralization in which, unlike traditional centralized systems where a single entity controls the network, the blockchain network 330 is decentralized. It consists of a network of distributed nodes, each maintaining a copy of the entire blockchain ledger. These nodes can be computers, servers, or even individual devices.

The transactions on the blockchain network 330 are performed by participants on the blockchain network. Each transaction contains information about the sender, receiver, amount, and any other relevant data. These transactions are broadcasted to the entire network. Then, a verification step occurs where once a transaction is broadcasted, it is grouped together with other transactions to form a block. Before a block is added to the blockchain, it needs to be verified by the network. Verification involves validating the transactions within the block, ensuring they are legitimate and adhere to the network's rules (in other words, by the conclusion of the consensus mechanism).

Consensus mechanisms are protocols that ensure all nodes on the network agree on the validity of transactions and the order in which they are added to the blockchain. Popular consensus mechanisms include Proof of Work (PoW), Proof of Stake (POS), and Practical Byzantine Fault Tolerance (PBFT). Each mechanism has its own way of reaching agreement and adding blocks to the chain.

Once a block is verified by the network, it is added to the blockchain in a linear, chronological order. Each block contains a reference to the previous block, forming a chain of blocks, hence the term “blockchain.” This linking ensures the immutability of the data stored on the blockchain, as altering any past block would require altering all subsequent blocks, which is computationally infeasible due to the cryptographic hash functions involved.

In some cases, participants (often referred to as miners or validators) are rewarded (with a “consensus reward”) for their efforts in securing and maintaining the network. This reward can be in the form of cryptocurrency, transaction fees, or other incentives. In the context of this disclosure, the consensus reward could relate to access to compute resources or access to premium services from compute resource providers.

Many blockchain networks also feature decentralized governance mechanisms where decisions about network upgrades, protocol changes, and other important matters are made through consensus among network participants. Note that the record on a distributed ledger of the blockchain network is recorded in an immutable manner and thus, the state of the data prior to recordation changes from it being able to be deleted or changed into being immutable where it cannot be changed or removed. The status of the data is transformed into a new state through its being recorded in a block of the blockchain on the distributed ledger.

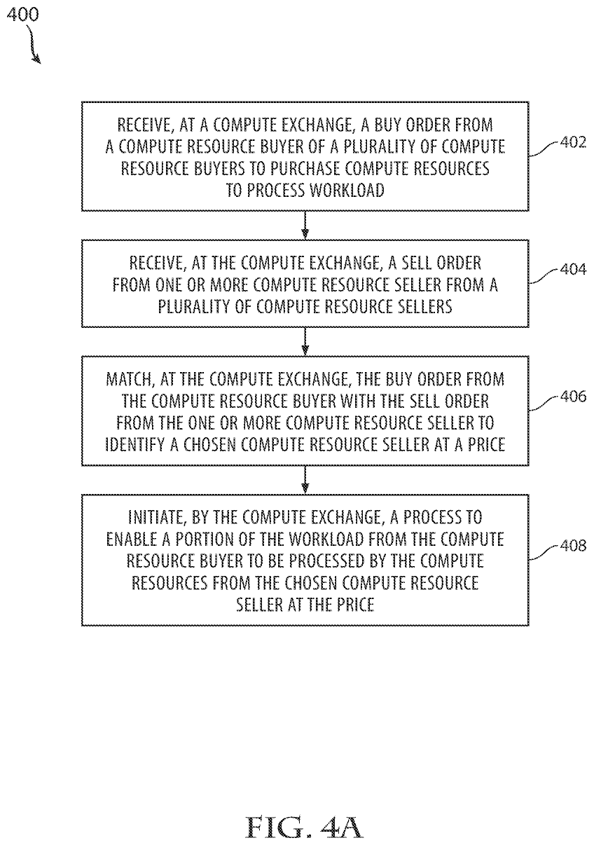

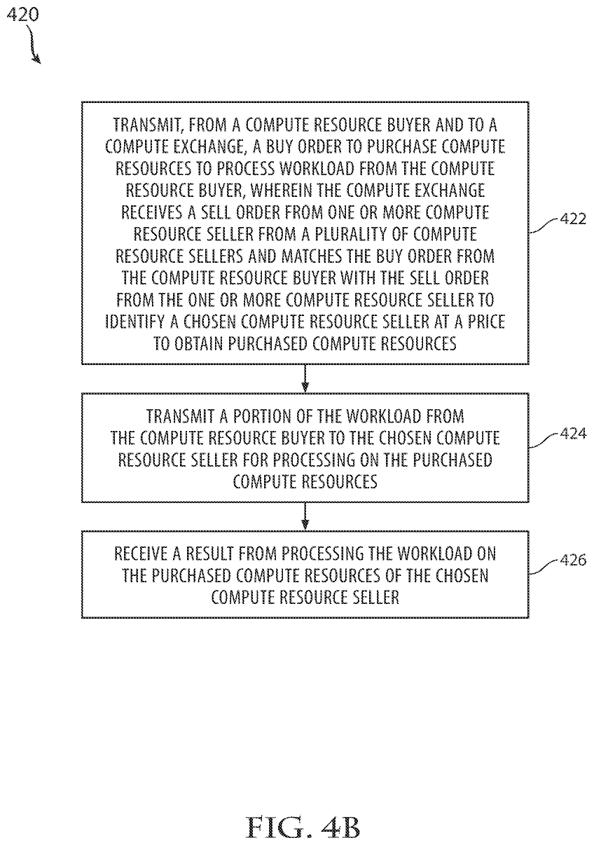

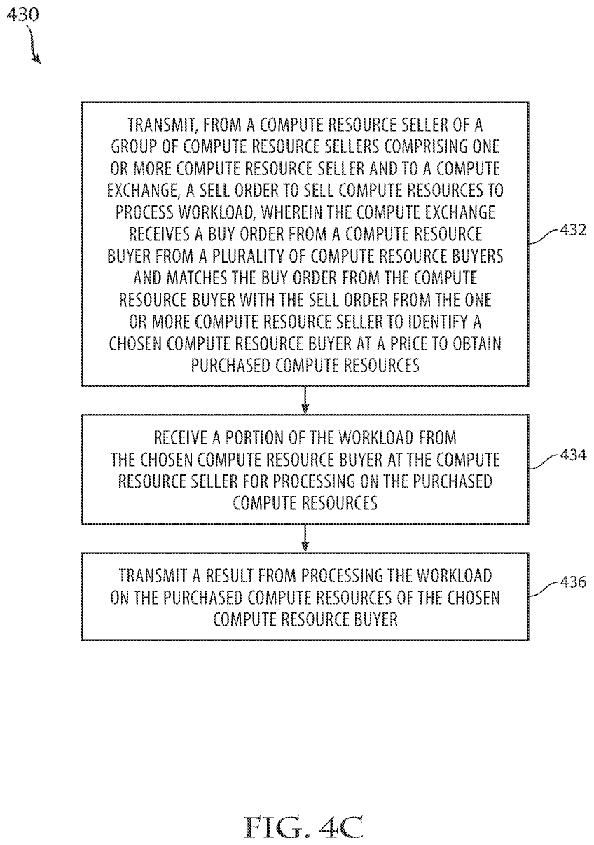

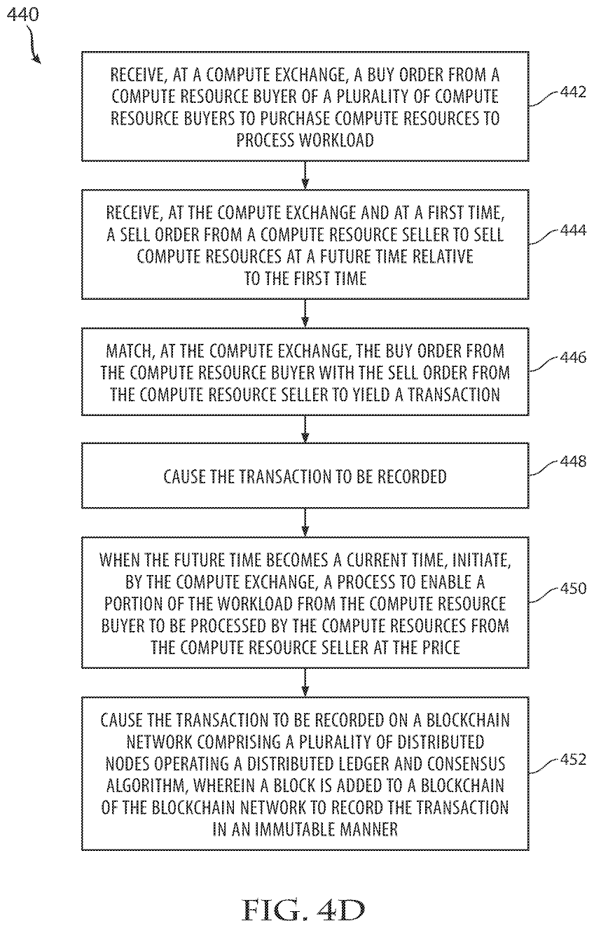

In some cases, the compute exchange 314 could also operate as a secondary market where people who have purchased access to compute resources that are to be used in the future can resell those compute resources either in a blockchain-based manner in which the ownership of the NFT or other blockchain proof of ownership is transferred to a new buyer or where ownership is otherwise confirmed. In this manner, the compute exchange 314 can not only act as a primary marketplace but also in some cases as a secondary marketplace for people to be able to buy and sell access to compute resources. FIG. 4D illustrates an example method covering the use of a blockchain network and the use of a secondary marketplace.

A non-fungible token (NFT) is a type of digital asset that represents ownership or proof of authenticity of a unique item or piece of content, typically stored on a blockchain 330. In this case, the NFT represents the ownership of compute resources which includes a time component in the future regrading when those compute resources are available for use. Unlike cryptocurrencies such as Bitcoin or Ethereum, which are fungible and can be exchanged on a one-to-one basis, NFTs are non-interchangeable and each one is distinct from another. In this disclosure, NFT's are one example of a blockchain-based record of a transaction in which ownership is established for the use of compute resources at a future point in time.

NFTs are often used to represent digital artworks, collectibles, virtual real estate, in-game items, music, videos, and other digital assets. Each NFT contains metadata that defines its unique characteristics and ownership information, which is securely stored and verified on the blockchain 330, usually Ethereum's blockchain using the ERC-721 or ERC-1155 token standards. Any blockchain network can be used to record the transaction however.

Ownership of an NFT is tracked on the blockchain through a smart contract, which ensures that the ownership history is transparent and immutable. The compute exchange 314 can include the programming of the smart contract which can be used to interact with buyers and sellers and record transactions of blockchain-based transactions on the distributed ledger. The approach allows creators and owners of the rights to access certain compute resources at certain times to prove the scarcity and authenticity of their digital assets, as well as to transfer ownership securely through peer-to-peer transactions on blockchain-based marketplaces.

The compute exchange 314 can include a blockchain interface which can include or coordinate with the smart contract to enable transactions that occur within the compute exchange 314 to be recorded on the blockchain network 330.

FIG. 4A illustrates an example method embodiment related to a compute exchange, according to some aspects of this disclosure.

As shown in FIG. 4A, a process 400 can be performed by a system which can include one or more of the computing device 700, the compute exchange 314, the software stack 108, a workload manager, a compute resource buyer or a group of compute resource buyers 313, a compute resource seller or a group of compute resource sellers 328, or a subset or combination thereof.

As block 402, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does receive, at a compute exchange, a buy order from a compute resource buyer of a plurality of compute resource buyers to purchase compute resources to process workload.

As block 402, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does receiving, at the compute exchange, a sell order from one or more compute resource seller from a plurality of compute resource sellers;

As block 404, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does match, at the compute exchange, the buy order from the compute resource buyer with the sell order from the one or more compute resource seller to identify a chosen compute resource seller at a price,

As block 406, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does initiate, by the compute exchange, a process to enable a portion of the workload from the compute resource buyer to be processed by the compute resources from the chosen compute resource seller at the price.

The system can further be configured to and does receive a registration of respective buyer accounts at the compute exchange from the plurality of compute resource buyers and receives a registration of respective seller accounts at the compute exchange from the plurality of compute resource sellers.

In some aspects, each compute resource seller of the plurality of compute resource sellers is a cloud service provider. In some aspects, the price is based on one or more of the buy order, the sell order, availability of access to the compute resources of the one or more compute resource seller, a characteristic of the workload, and characteristics of the compute resources at the chosen compute resource seller.

The price can be further based on respective real-time pricing of respective cloud compute resources from the plurality of compute resource sellers based on a current demand for the respective cloud compute resources. The step of determining the chosen compute resource seller can occur by a user selection or an automated selection by the compute exchange based on one or more parameters.

The system can further be configured to and does receive characteristics of the compute resources from the plurality of compute resource sellers that would be offered at real-time pricing. The chosen compute resource seller can be determined based on the price being a lowest-price for the real-time pricing or characteristics of the compute resources from the chosen compute resource seller even when the compute resources are not lowest-priced compute resources.

The system can further be configured to and does determines the chosen compute resource seller based on real-time status data about an on-premises compute environment associated with the compute resource buyer.

In some aspects, the compute exchange 314 can include one or more of a workload manager, a high-performance computing suite, an on-demand data center engine and one or more applications available for the compute resource buyer.

The system can further be configured to and does cause, by the compute exchange, a deployment of a second portion of the workload on an on-premises compute environment of the compute resource buyer.

In another aspect, the system can further be configured to and does cause, via the compute exchange, a division of the workload into the portion of the workload and a second portion of the workload and cause, via the compute exchange, a deployment of the portion of the workload on the chosen compute resource seller and a deployment of the second portion of the workload on a second compute environment.

The second compute environment can include an on-premises compute environment of the compute resource buyer.

In some aspects, a system for operating a compute exchange can include at least one processor; and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.

In some aspects, a computer-readable storage device storing instructions which, when executed by at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.

In another aspect, a compute exchange 314 can include one or more: means for receiving, at a compute exchange, a buy order from a compute resource buyer of a plurality of compute resource buyers to purchase compute resources to process workload; means for receiving, at the compute exchange, a sell order from one or more compute resource seller from a plurality of compute resource sellers; means for matching, at the compute exchange, the buy order from the compute resource buyer with the sell order from the one or more compute resource seller to identify a chosen compute resource seller at a price; and means for initiating, from the compute exchange, a process to enable a portion of the workload from the compute resource buyer to be processed by the compute resources from the chosen compute resource seller at the price.

FIG. 4B illustrates an example method embodiment related to a compute resource buyer, according to some aspects of this disclosure. In other words, the focus of this embodiment relates to processes being performed by a compute resource buyer or primarily be the compute resource buyer. As shown in FIG. 4B, a process 420 can be performed by a system which can include one or more of the computing device 700, the compute exchange 314, the software stack 108, a workload manager, a compute resource buyer or a group of compute resource buyers 313, a compute resource seller or a group of compute resource sellers 328, or a subset or combination thereof.

At block 422, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does transmit, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources.

At block 424, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does transmit a portion of the workload from the compute resource buyer to the chosen compute resource seller for processing on the purchased compute resources.

At block 426, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does receive a result from processing the workload on the purchased compute resources of the chosen compute resource seller.

The system can further be configured to pay the price to the chosen compute resource seller for the purchased compute resources. Each compute resource seller of the plurality of compute resource sellers 328 can be a cloud service provider. The price can be based on one or more of the buy order, the sell order, availability of access to the compute resources of the one or more compute resource seller, a characteristic of the workload, and characteristics of the compute resources at the chosen compute resource seller.

In some aspects, the price can be further based on respective real-time pricing of respective cloud compute resources from the plurality of compute resource sellers based on a current demand for the respective cloud compute resources.

The chosen compute resource seller can be determined by the compute resource buyer selecting an option or by an automated selection by the compute exchange based on one or more parameters.

In some aspects, the compute exchange 314 can receive characteristics of the compute resources from the plurality of compute resource sellers that would be offered at real-time pricing. The chosen compute resource seller can be determined based on the price being a lowest-price for the real-time pricing or characteristics of the compute resources from the chosen compute resource seller even when the compute resources are not lowest-priced compute resources.

The chosen compute resource seller can be determined based on real-time status data about an on-premises compute environment associated with the compute resource buyer. The compute exchange 314 can include one or more of a workload manager, a high-performance computing suite, an on-demand data center engine and one or more applications available for the compute resource buyer.

The system can further be configured to deploy, by the compute resource buyer, a second portion of the workload on an on-premises compute environment of the compute resource buyer. The system can further be configured to divide the workload into the portion of the workload and a second portion of the workload and deploy the portion of the workload on the purchased compute resources of the chosen compute resource seller and a deploying the second portion of the workload on a second compute environment. In some aspects, the second compute environment can include an on-premises compute environment of the compute resource buyer.

In some aspects, a system can include at least one processor; and a computer-readable storage device storing instructions which, when executed by the at least one processor, cause the at least one processor to be configured to: transmit, from the system and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.

In another aspect, a system can include one or more of: means for transmitting, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; means for transmitting a portion of the workload from the compute resource buyer to the chosen compute resource seller for processing on the purchased compute resources; and means for receiving a result from processing the workload on the purchased compute resources of the chosen compute resource seller.

In another aspect, a computer-readable storage device storing instructions which, when executed by at least one processor, cause the at least one processor to be configured to: transmit, from a compute resource buyer and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.

FIG. 4C illustrates an illustrates an example method embodiment related to a compute resource seller, according to some aspects of this disclosure. As shown in FIG. 4C, a process 430 can be performed by a system which can include one or more of the computing device 700, the compute exchange 314, the software stack 108, a workload manager, a compute resource buyer or a group of compute resource buyers 313, a compute resource seller or a group of compute resource sellers 328, or a subset or combination thereof.

At block 432, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does transmit, from a compute resource seller of a group of compute resource sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources.

At block 434, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does receive a portion of the workload from the chosen compute resource buyer at the compute resource seller for processing on the purchased compute resources.

At block 436, a system (e.g., the computing device 700, the compute exchange 314, the software stack 108, a workload manager, a compute resource buyer or a group of compute resource buyers 313, a compute resource seller or a group of compute resource sellers 328, or a subset or combination thereof) can and does transmit a result from processing the workload on the purchased compute resources of the chosen compute resource buyer.

The system can further be configured to receive a payment of the price from the chosen compute resource buyer for the purchased compute resources. Each compute resource seller of the group of compute resource sellers can be a cloud service provider.

The price can be based on one or more of the buy order, the sell order, availability of access to the compute resources of the group of compute resource sellers, a characteristic of the workload, and characteristics of the compute resources at the compute resource seller.

In other aspects, the price can further be based on respective real-time pricing of respective cloud compute resources from the group of compute resource sellers based on a current demand for the compute resources.

The chosen compute resource buyer can be determined by the compute resource buyer selecting an option or by an automated selection by the compute exchange based on one or more parameters. In some aspects, the compute exchange receives characteristics of the compute resources from the group of compute resource sellers that would be offered at real-time pricing, wherein the chosen compute resource buyer is determined based on the price being a lowest-price for the real-time pricing or characteristics of the compute resources from the compute resource seller even when the compute resources are not lowest-priced compute resources.

The chosen compute resource buyer can be determined based on real-time status data about an on-premises compute environment associated with the compute resource buyer. The compute exchange can include one or more of: a workload manager, a high-performance computing suite, an on-demand data center engine and one or more applications available for the compute resource buyer. The portion of the workload can include less than a full amount of the workload. In some aspects, the compute resource buyer divides the workload into the portion of the workload and a second portion of the workload. In this regard, the system can be configured to receive the portion of the workload at the compute resource seller. A second compute environment can process the second portion of the workload.

In some aspects, a system can include at least one processor; and a computer-readable storage device storing instructions which, when executed by the at least one processor, cause the at least one processor to be configured to: transmit, from the system which comprises a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.

In other aspects, a system can include one or more of: means for transmitting, from a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; means for receiving a portion of the workload from the chosen compute resource buyer at the compute resource seller for processing on the purchased compute resources; and means for transmitting a result from processing the workload on the purchased compute resources of the chosen compute resource buyer.

In another aspects, a computer-readable storage device storing instructions which, when executed by at least one processor, cause the at least one processor to be configured to: transmit, from a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.

FIG. 4D illustrates an illustrates an example method embodiment related to a compute resource seller, according to some aspects of this disclosure. As shown in FIG. 4D, a process 440 can be performed by a system which can include one or more of the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof. The process 440 can be embodied in any one or more of these components and may include processes from any one of the components as well.

At block 442, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does receive, at a compute exchange, a buy order from a compute resource buyer of a plurality of compute resource buyers to purchase compute resources to process workload.

At block 444, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does receive, at the compute exchange and at a first time, a sell order from a compute resource seller to sell compute resources at a future time relative to the first time.

At block 446, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does match, at the compute exchange, the buy order from the compute resource buyer with the sell order from the compute resource seller to yield a transaction.

At block 448, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does cause the transaction to be recorded.

At block 450, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does, when the future time becomes a current time, initiate, by the compute exchange, a process to enable a portion of the workload from the compute resource buyer to be processed by the compute resources from the compute resource seller at a price.

At block 452, a system (e.g., the computing device 700, the compute exchange 314, the software stack 108, a workload manager, a compute resource buyer or a group of compute resource buyers 313, a compute resource seller or a group of compute resource sellers 328, a blockchain network 330, or a subset or combination thereof) can and does cause the transaction to be recorded on a blockchain network comprising a plurality of distributed nodes operating a distributed ledger and consensus algorithm, wherein a block is added to a blockchain of the blockchain network to record the transaction in an immutable manner.

The compute resource seller may be one of a plurality of compute resource sellers and provide offers to the compute exchange for the use of compute resources at a future time or multiple future times. A price for the compute resources can be offered or accepted based on one or more of the buy order, the sell order, availability of access to the compute resources of the compute resource seller at the future time, a characteristic of the workload, and characteristics of the compute resources at the compute resource seller. For example, compute resources for use in one month might be cheaper than an offer for the use of compute resources immediately or on-demand. Buyer might be able to purchase flexibility as well, such as the opportunity to use the compute resources as a highest priority user over a period of two weeks.

Buyers may be able to divide their workload and purchase different compute resources (i.e., physically, temporally, or both) for different portions of their workload.

The price for the compute resources can be based on respective real-time pricing of respective cloud compute resources from the compute resource seller based on a current demand for the respective cloud compute resources at the first time or the future time.

The process 440 can further include receiving characteristics of the compute resource seller that would be offered at real-time pricing, wherein the compute resource seller is determined from a group of compute resources sellers based on a price being a lowest-price for the real-time pricing or characteristics of the compute resources from the compute resource seller even when the compute resources are not lowest-priced compute resources.

In some cases, the compute exchange 314 can include one or more of: a workload manager, a high-performance computing suite, an on-demand data center engine, one or more applications available for the compute resource buyer, a blockchain-based smart contract and a blockchain interface for communicating transitions to a blockchain network.

The compute exchange in some cases can cause a deployment of a second portion of the workload on an on-premises compute environment of the compute resource buyer. In other aspects, the compute exchange can cause a division of the workload into a first portion of the workload and a second portion of the workload and cause a deployment of the first portion of the workload on the compute resources at the future time at the compute resource seller and a deployment of the second portion of the workload on a second compute environment. The second compute environment comprises an on-premises compute environment of the compute resource buyer. In another aspect, the second compute environment comprises second compute resources at the compute resource seller at a different time than the future time.

In some aspects, a system can include at least one processor and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.

The computer-readable storage device can store additional instructions which, when executed by the at least one processor, cause the at least one processor to be configured to: when the future time becomes a current time, initiate, by the compute exchange, a process to enable a portion of the workload from the compute resource buyer to be processed by the compute resources from the compute resource seller at a price.

The computer-readable storage device can store instructions which, when executed by the at least one processor, cause the at least one processor to be configured to: cause the transaction to be recorded on a blockchain network comprising a plurality of distributed nodes operating a distributed ledger and consensus algorithm, wherein a block is added to a blockchain of the blockchain network to record the transaction in an immutable manner.

In some aspects, a system includes one or more: means for receiving, at a compute exchange, a buy order from a compute resource buyer of a plurality of compute resource buyers to purchase compute resources to process workload; means for receiving, at the compute exchange and at a first time, a sell order from a compute resource seller to sell compute resources at a future time relative to the first time; means for matching, at the compute exchange, the buy order from the compute resource buyer with the sell order from the compute resource seller to yield a transaction; and means for causing the transaction to be recorded.

The system can further include means for, when the future time becomes a current time, initiating, by the compute exchange, a process to enable a portion of the workload from the compute resource buyer to be processed by the compute resources from the compute resource seller at a price.

In some aspects, the system can further include means for causing the transaction to be recorded on a blockchain network comprising a plurality of distributed nodes operating a distributed ledger and consensus algorithm, wherein a block is added to a blockchain of the blockchain network to record the transaction in an immutable manner.

A computer-readable storage device can store instructions which, when executed by at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.

The computer-readable storage device can store additional instructions which, when executed by at least one processor, cause the at least one processor to be configured to: when the future time becomes a current time, initiate, by the compute exchange, a process to enable a portion of the workload from the compute resource buyer to be processed by the compute resources from the compute resource seller at a price.

The computer-readable storage device can store additional instructions which, when executed by at least one processor, cause the at least one processor to be configured to: cause the transaction to be recorded on a blockchain network comprising a plurality of distributed nodes operating a distributed ledger and consensus algorithm, wherein a block is added to a blockchain of the blockchain network to record the transaction in an immutable manner.

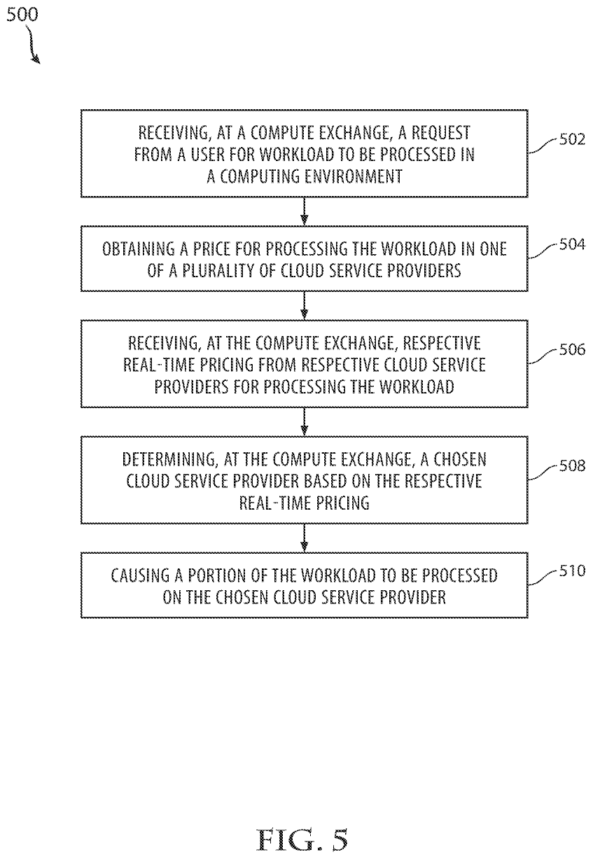

FIG. 5 illustrates an example method 500 for operating a compute exchange. The method 500 can be performed by the compute exchange interface 104, a cloudmart 112, and/or an on-premises infrastructure 116, a computing system 500 as shown in FIG. 5, or any subsystem thereof.

At operation 502, an apparatus or system (e.g., the compute exchange interface 104, a cloudmart 112, and/or an on-premises infrastructure 116, a computing system 500 as shown in FIG. 5, or any subsystem thereof) can and does receive, at a compute exchange, a request from a user for workload to be processed in a computing environment. The compute exchange can include one or more of a workload manager, a high-performance computing suite, an on-demand data center engine and one or more applications available for the user.

At operation 504, an apparatus or system (e.g., the compute exchange interface 104, a cloudmart 112, and/or an on-premises infrastructure 116, a computing system 500 as shown in FIG. 5, or any subsystem thereof 108, the workload manager 114, the computing system 600, or at least one subsystem thereof) can and does obtain a price for processing the workload in one of a plurality of cloud service providers. The price can be obtained from the user or obtained by the compute exchange based on characteristics of the workload.

At operation 506, an apparatus or system (e.g., the compute exchange interface 104, a cloudmart 112, and/or an on-premises infrastructure 116, a computing system 500 as shown in FIG. 5, or any subsystem thereof) can and does receive, at the compute exchange, respective real-time pricing from respective cloud service providers for processing the workload. The respective real-time pricing of respective cloud compute resources can be based on a current demand or based on the price.

At operation 508, an apparatus or system (e.g., the compute exchange interface 104, a cloudmart 112, and/or an on-premises infrastructure 116, a computing system 500 as shown in FIG. 5, or any subsystem thereof) can and does determine, at the compute exchange, a chosen cloud service provider based on the respective real-time pricing. Determining the chosen cloud service provider can occur by a user selection or an automated selection by the compute exchange based on one or more parameters.

The method 500 can further include receiving characteristics of compute resources that would be offered at the respective real-time pricing. The chosen cloud service provider can be determined based on a lowest-price for the respective real-time pricing or the characteristics of the compute resources even when the compute resources are not lowest-priced compute resources.

In some aspects, the method 500 can include determining the chosen cloud service provider based on real-time status data about an on-premises compute environment associated with the user.

In some aspects, the method 500 can include deploying a second portion of the workload on an on-premises compute environment. In another aspect, the method 500 can include dividing up the workload into the portion of the workload and a second portion of the workload and deploying the portion of the workload on the chosen cloud service provider and deploying the second portion of the workload on a second compute environment. In some aspects, the second compute environment includes an on-premises compute environment.

In some aspects, a system for operating a compute exchange, the system includes at least one processor; and a computer-readable storage device storing instructions which, when executed by the at least one processor, cause the at least one processor to be configured to: receive, at the compute exchange, a request from a user for workload to be processed in a computing environment; obtain a price for processing the workload in one of a plurality of cloud service providers; receive, at the compute exchange, respective real-time pricing from respective cloud service providers for processing the workload; determine, at the compute exchange, a chosen cloud service provider based on the respective real-time pricing; and cause a portion of the workload to be processed on the chosen cloud service provider.

In some aspects, a computer-readable storage device stores instructions which, when executed by at least one processor, cause the at least one processor to be configured to: receive, at a compute exchange, a request from a user for workload to be processed in a computing environment; obtain a price for processing the workload in one of a plurality of cloud service providers; receive, at the compute exchange, respective real-time pricing from respective cloud service providers for processing the workload; determine, at the compute exchange, a chosen cloud service provider based on the respective real-time pricing; and cause a portion of the workload to be processed on the chosen cloud service provider.

In some aspects, a compute exchange can include means for receiving, at the compute exchange, a request from a user for workload to be processed in a computing environment; means for obtaining a price for processing the workload in one of a plurality of cloud service providers; means for receiving, at the compute exchange, respective real-time pricing from respective cloud service providers for processing the workload; means for determining, at the compute exchange, a chosen cloud service provider based on the respective real-time pricing; and means for causing a portion of the workload to be processed on the chosen cloud service provider.

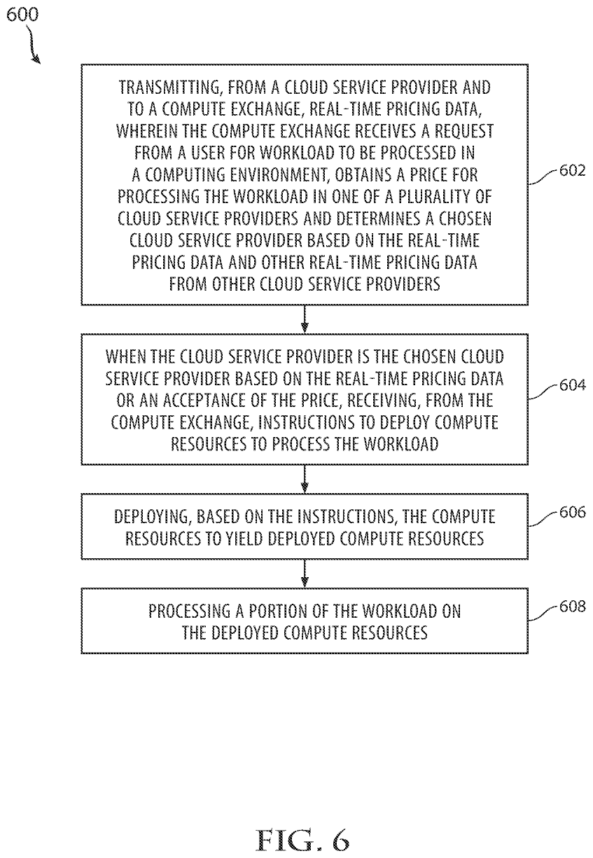

FIG. 6 illustrates an example method 600 for operating a compute exchange from the standpoint of a cloud service provider. The method 600 can be performed by the compute exchange interface 104, a cloudmart 112, and/or an on-premises infrastructure 116, a computing system 500 as shown in FIG. 5, or any subsystem thereof.

At operation 602, an apparatus or system (e.g., the compute exchange interface 104, a cloudmart 112, and/or an on-premises infrastructure 116, a computing system 500 as shown in FIG. 5, or any subsystem thereof) can and does transmit, from a cloud service provider and to a compute exchange, real-time pricing data, wherein the compute exchange receives a request from a user for workload to be processed in a computing environment, obtains a price for processing the workload in one of a plurality of cloud service providers and determines a chosen cloud service provider based on the real-time pricing data and other real-time pricing data from other cloud service providers. The price can be obtained from the user or obtained by the compute exchange based on characteristics of the workload.

In some aspects, the compute exchange can manage how the chosen cloud service provider is chosen by enabling a user selection or an automated selection based on one or more parameters. In some aspects, the method can include transmitting, to the compute exchange, characteristics of the compute resources that would be offered at the real-time pricing data. The chosen cloud service provider can be determined based on a lowest-price or the characteristics of the compute resources even when the compute resources are not lowest-priced compute resources. The compute exchange can determine the chosen cloud service provider based on real-time status data about an on-premises compute environment associated with the user.

In some aspects, the compute exchange can include one or more of: a workload manager, a high-performance computing suite, an on-demand data center engine and one or more applications available for the user.

At operation 604, an apparatus or system (e.g., the compute exchange interface 104, a cloudmart 112, and/or an on-premises infrastructure 116, a computing system 500 as shown in FIG. 5, or any subsystem thereof 108, the workload manager 114, the computing system 600, or at least one subsystem thereof) can and does, when the cloud service provider is the chosen cloud service provider based on the real-time pricing data or an acceptance of the price, receive, from the compute exchange, instructions to deploy compute resources to process the workload. The real-time pricing data of the cloud service provider can be based on a current demand or based on the price.

At operation 606, an apparatus or system (e.g., the compute exchange interface 104, a cloudmart 112, and/or an on-premises infrastructure 116, a computing system 500 as shown in FIG. 5, or any subsystem thereof) can and does deploy, based on the instructions, the compute resources to yield deployed compute resources.

At operation 608, an apparatus or system (e.g., the compute exchange interface 104, a cloudmart 112, and/or an on-premises infrastructure 116, a computing system 500 as shown in FIG. 5, or any subsystem thereof) can and does process a portion of the workload on the deployed compute resources.

The compute exchange can also divide up the workload into the portion of the workload and a second portion of the workload and cause to be deployed the portion of the workload on the chosen cloud service provider and cause to be deployed the second portion of the workload on a second compute environment. In some aspects, the compute exchange can cause to be deployed a second portion of the workload on an on-premises compute environment.

In some aspects, a system for operating a cloud service provider includes at least one processor; and a computer-readable storage device storing instructions which, when executed by the at least one processor, cause the at least one processor to be configured to: transmit, from a cloud service provider and to a compute exchange, real-time pricing data, wherein the compute exchange receives a request from a user for workload to be processed in a computing environment, obtains a price for processing the workload in one of a plurality of cloud service providers and determines a chosen cloud service provider based on the real-time pricing data and other real-time pricing data from other cloud service providers; when the cloud service provider is the chosen cloud service provider based on the real-time pricing data or an acceptance of the price, receive, from the compute exchange, instructions to deploy compute resources to process the workload; deploy, based on the instructions, the compute resources to yield deployed compute resources; and process a portion of the workload on the deployed compute resources.

In some aspects, a computer-readable storage device stores instructions which, when executed by at least one processor associated with a cloud service provider, cause the at least one processor to be configured to: transmit, to a compute exchange, real-time pricing data, wherein the compute exchange receives a request from a user for workload to be processed in a computing environment, obtains a price for processing the workload in one of a plurality of cloud service providers and determines a chosen cloud service provider based on the real-time pricing data and other real-time pricing data from other cloud service providers; when the cloud service provider is the chosen cloud service provider based on the real-time pricing data or an acceptance of the price, receive, from the compute exchange, instructions to deploy compute resources to process the workload; deploy, based on the instructions, the compute resources to yield deployed compute resources; and process a portion of the workload on the deployed compute resources.

In some aspects, a cloud service provider includes one or more: means for transmitting, to a compute exchange, real-time pricing data, wherein the compute exchange receives a request from a user for workload to be processed in a computing environment, obtains a price for processing the workload in one of a plurality of cloud service providers and determines a chosen cloud service provider based on the real-time pricing data and other real-time pricing data from other cloud service providers; means for, when the cloud service provider is the chosen cloud service provider based on the real-time pricing data or an acceptance of the price, receiving, from the compute exchange, instructions to deploy compute resources to process the workload; means for deploying, based on the instructions, the compute resources to yield deployed compute resources; and means for processing a portion of the workload on the deployed compute resources.

Any of the methods or processes disclosed herein can be claimed or described from the standpoint of any individual component in the system such as the compute exchange such as from the standpoint of the compute exchange 314, or an individual compute buyer 302 or group of compute buyers 313, or an individual compute provider 316 or group of compute providers 328 or sellers. Components such as a blockchain network 330 and/or a software stack 108 may also perform operations which can be claimed or described separately as those components interact with other components in the overall system shown in FIG. 3. Any such operations, even if not explicitly described, would be understood as part of this disclosure.

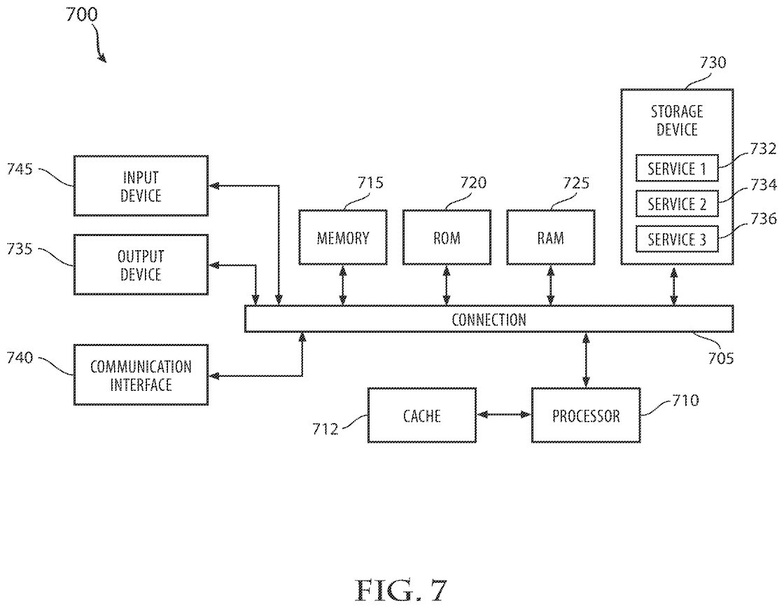

FIG. 7 is a diagram illustrating an example of a system for implementing certain aspects of the present disclosure. In particular, FIG. 7 illustrates an example of computing system 700, which can be for example any computing device making up a computing system, a camera system, or any component thereof in which the components of the system are in communication with each other using connection 705. Connection 705 can be a physical connection using a bus, or a direct connection into processor 712, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 712. Computing system 700 can include a cache 711 of high-speed memory connected directly with, in close proximity to, or integrated as part of processor 712.

Processor 712 can include any general purpose processor and a hardware service or software service, such as services 732, 734, and 736 stored in storage device 730, configured to control processor 712 as well as a special-purpose processor where software instructions are incorporated into the actual processor design. Processor 712 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 712, it causes the system to perform a function. In some examples, a hardware service that performs a particular function can include the software component stored in a computer-readable medium in connection with the necessary hardware components, such as processor 712, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

The present disclosure incorporates by reference the paper included as Appendix A.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim clauses of this application include:
Clause 1. A method comprising: receiving, at a compute exchange, a buy order from a compute resource buyer of a plurality of compute resource buyers to purchase compute resources to process workload; receiving, at the compute exchange, a sell order from one or more compute resource seller from a plurality of compute resource sellers; matching, at the compute exchange, the buy order from the compute resource buyer with the sell order from the one or more compute resource seller to identify a chosen compute resource seller at a price; and initiating, by the compute exchange, a process to enable a portion of the workload from the compute resource buyer to be processed by the compute resources from the chosen compute resource seller at the price.
Clause 2. The method of clause 1, further comprising: receiving a registration of respective buyer accounts at the compute exchange from the plurality of compute resource buyers; and receiving a registration of respective seller accounts at the compute exchange from the plurality of compute resource sellers.
Clause 3. The method of clause 2 or any previous clause, wherein each compute resource seller of the plurality of compute resource sellers is a cloud service provider.
Clause 4. The method of clause 1 or any previous clause, wherein the price is based on one or more of the buy order, the sell order, availability of access to the compute resources of the one or more compute resource seller, a characteristic of the workload, and characteristics of the compute resources at the chosen compute resource seller.
Clause 5. The method of clause 1 or any previous clause, wherein the price is further based on respective real-time pricing of respective cloud compute resources from the plurality of compute resource sellers based on a current demand for the respective cloud compute resources.
Clause 6. The method of clause 1 or any previous clause, wherein determining the chosen compute resource seller occurs by a user selection or an automated selection by the compute exchange based on one or more parameters.
Clause 7. The method of clause 1 or any previous clause, further comprising: receiving characteristics of the compute resources from the plurality of compute resource sellers that would be offered at real-time pricing, wherein the chosen compute resource seller is determined based on the price being a lowest-price for the real-time pricing or characteristics of the compute resources from the chosen compute resource seller even when the compute resources are not lowest-priced compute resources.
Clause 8. The method of clause 1 or any previous clause, further comprising: determining the chosen compute resource seller based on real-time status data about an on-premises compute environment associated with the compute resource buyer.
Clause 9. The method of clause 1 or any previous clause, wherein the compute exchange comprises: a workload manager, a high-performance computing suite, an on-demand data center engine and one or more applications available for the compute resource buyer.
Clause 10. The method of clause 1 or any previous clause, further comprising: causing, by the compute exchange, a deployment of a second portion of the workload on an on-premises compute environment of the compute resource buyer.
Clause 11. The method of clause 1 or any previous clause, further comprising: causing, via the compute exchange, a division of the workload into the portion of the workload and a second portion of the workload; and causing, via the compute exchange, a deployment of the portion of the workload on the chosen compute resource seller and a deployment of the second portion of the workload on a second compute environment.
Clause 12. The method of clause 11 or any previous clause, wherein the second compute environment comprises an on-premises compute environment of the compute resource buyer.
Clause 13. A system for operating a compute exchange, the system comprising: at least one processor; and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.
Clause 14. The system of clause 13, wherein the computer-readable storage device stores instructions which, when executed by the at least one processor, cause the at least one processor to be configured to: receive a registration of respective buyer accounts at the compute exchange from the plurality of compute resource buyers; and receive a registration of respective seller accounts at the compute exchange from the plurality of compute resource sellers.
Clause 15. The system of clause 14, wherein each compute resource seller of the plurality of compute resource sellers is a cloud service provider.
Clause 16. The system of clause 13 or any previous clause, wherein the price is based on one or more of the buy order, the sell order, availability of access to the compute resources of the one or more compute resource seller, a characteristic of the workload, and characteristics of the compute resources at the chosen compute resource seller.
Clause 17. The system of clause 13 or any previous clause, wherein the price is further based on respective real-time pricing of respective cloud compute resources from the plurality of compute resource sellers based on a current demand for respective cloud compute resources.
Clause 18. The system of clause 13 or any previous clause, wherein determining the chosen compute resource seller occurs by a user selection or an automated selection by the compute exchange based on one or more parameters.
Clause 19. The system of clause 13 or any previous clause, wherein the computer-readable storage device stores instructions which, when executed by the at least one processor, cause the at least one processor to be configured to: receive characteristics of the compute resources from the plurality of compute resource sellers that would be offered at real-time pricing, wherein the chosen compute resource seller is determined based on the price being a lowest-price for the real-time pricing or characteristics of the compute resources from the chosen compute resource seller even when the compute resources are not lowest-priced compute resources.
Clause 20. The system of clause 13 or any previous clause, wherein the computer-readable storage device stores instructions which, when executed by the at least one processor, cause the at least one processor to be configured to: determine the chosen compute resource seller based on real-time status data about an on-premises compute environment associated with the compute resource buyer.
Clause 21. The system of clause 13 or any previous clause, wherein the compute exchange comprises: a workload manager, a high-performance computing suite, an on-demand data center engine and one or more applications available for the compute resource buyer.
Clause 22. The system of clause 13 or any previous clause, wherein the computer-readable storage device stores instructions which, when executed by the at least one processor, cause the at least one processor to be configured to: cause, by the compute exchange, a deployment of a second portion of the workload on an on-premises compute environment of the compute resource buyer.
Clause 23. The system of clause 13 or any previous clause, wherein the computer-readable storage device stores instructions which, when executed by the at least one processor, cause the at least one processor to be configured to: cause, via the compute exchange, a division of the workload into the portion of the workload and a second portion of the workload; and cause, via the compute exchange, a deployment of the portion of the workload on the chosen compute resource seller and a deployment of the second portion of the workload on a second compute environment.
Clause 24. The system of clause 23 or any previous clause, wherein the second compute environment comprises an on-premises compute environment of the compute resource buyer.
Clause 25. A computer-readable storage device storing instructions which, when executed by at least one processor, cause the at least one processor to be configured to: receive, at a compute exchange, a buy order from a compute resource buyer of a plurality of compute resource buyers to purchase compute resources to process workload; receive, at the compute exchange, a sell order from one or more compute resource seller from a plurality of compute resource sellers; match, at the compute exchange, the buy order from the compute resource buyer with the sell order from the one or more compute resource seller to identify a chosen compute resource seller at a price; and initiate, by the compute exchange, a process to enable a portion of the workload from the compute resource buyer to be processed by the compute resources from the chosen compute resource seller at the price.
Clause 26. A compute exchange comprising: means for receiving, at a compute exchange, a buy order from a compute resource buyer of a plurality of compute resource buyers to purchase compute resources to process workload; means for receiving, at the compute exchange, a sell order from one or more compute resource seller from a plurality of compute resource sellers; means for matching, at the compute exchange, the buy order from the compute resource buyer with the sell order from the one or more compute resource seller to identify a chosen compute resource seller at a price; and means for initiating, from the compute exchange, a process to enable a portion of the workload from the compute resource buyer to be processed by the compute resources from the chosen compute resource seller at the price.
Clause 27. A method comprising: transmitting, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmitting a portion of the workload from the compute resource buyer to the chosen compute resource seller for processing on the purchased compute resources; and receiving a result from processing the workload on the purchased compute resources of the chosen compute resource seller.
Clause 28. The method of clause 27, further comprising: paying the price to the chosen compute resource seller for the purchased compute resources.
Clause 29. The method of clause 27 or any previous clause, wherein each compute resource seller of the plurality of compute resource sellers is a cloud service provider.
Clause 30. The method of clause 27 or any previous clause, wherein the price is based on one or more of the buy order, the sell order, availability of access to the compute resources of the one or more compute resource seller, a characteristic of the workload, and characteristics of the compute resources at the chosen compute resource seller.
Clause 31. The method of clause 27 or any previous clause, wherein the price is further based on respective real-time pricing of respective cloud compute resources from the plurality of compute resource sellers based on a current demand for the respective cloud compute resources.
Clause 32. The method of clause 27 or any previous clause, wherein the chosen compute resource seller is determined by the compute resource buyer selecting an option or by an automated selection by the compute exchange based on one or more parameters.
Clause 33. The method of clause 27 or any previous clause, wherein the compute exchange receives characteristics of the compute resources from the plurality of compute resource sellers that would be offered at real-time pricing, wherein the chosen compute resource seller is determined based on the price being a lowest-price for the real-time pricing or characteristics of the compute resources from the chosen compute resource seller even when the compute resources are not lowest-priced compute resources.
Clause 34. The method of clause 27 or any previous clause, wherein the chosen compute resource seller is determined based on real-time status data about an on-premises compute environment associated with the compute resource buyer.
Clause 35. The method of clause 27 or any previous clause, wherein the compute exchange comprises: a workload manager, a high-performance computing suite, an on-demand data center engine and one or more applications available for the compute resource buyer.
Clause 36. The method of clause 27 or any previous clause, further comprising: deploying, by the compute resource buyer, a second portion of the workload on an on-premises compute environment of the compute resource buyer.
Clause 37. The method of clause 27 or any previous clause, further comprising: dividing the workload into the portion of the workload and a second portion of the workload; and deploying the portion of the workload on the purchased compute resources of the chosen compute resource seller and a deploying the second portion of the workload on a second compute environment.
Clause 38. The method of clause 37 or any previous clause, wherein the second compute environment comprises an on-premises compute environment of the compute resource buyer.
Clause 39. A system comprising: at least one processor; and a computer-readable storage device storing instructions which, when executed by the at least one processor, cause the at least one processor to be configured to: transmit, from the system and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.
Clause 40. A system comprising: means for transmitting, from a compute resource buyer and to a compute exchange, a buy order to purchase compute resources to process workload from the compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; means for transmitting a portion of the workload from the compute resource buyer to the chosen compute resource seller for processing on the purchased compute resources; and means for receiving a result from processing the workload on the purchased compute resources of the chosen compute resource seller.
Clause 41. A computer-readable storage device storing instructions which, when executed by at least one processor, cause the at least one processor to be configured to: transmit, from a compute resource buyer and to a compute exchange, a buy order to purchase compute resources to process workload from a compute resource buyer, wherein the compute exchange receives a sell order from one or more compute resource seller from a plurality of compute resource sellers and matches the buy order from the compute resource buyer with the sell order from the one or more compute resource seller to identify a chosen compute resource seller at a price to obtain purchased compute resources; transmit a portion of the workload from the compute resource buyer to the chosen compute resource seller for processing on the purchased compute resources; and receive a result from processing the workload on the purchased compute resources of the chosen compute resource seller.
Clause 42. A method comprising: transmitting, from a compute resource seller of a group of compute resource sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receiving a portion of the workload from the chosen compute resource buyer at the compute resource seller for processing on the purchased compute resources; and transmitting a result from processing the workload on the purchased compute resources of the chosen compute resource buyer.
Clause 43. The method of clause 42, further comprising: receiving a payment of the price from the chosen compute resource buyer for the purchased compute resources.
Clause 44. The method of clause 42 or any previous clause, wherein each compute resource seller of the group of compute resource sellers is a cloud service provider.
Clause 45. The method of clause 42 or any previous clause, wherein the price is based on one or more of the buy order, the sell order, availability of access to the compute resources of the group of compute resource sellers, a characteristic of the workload, and characteristics of the compute resources at the compute resource seller.
Clause 46. The method of clause 42 or any previous clause, wherein the price is further based on respective real-time pricing of respective cloud compute resources from the group of compute resource sellers based on a current demand for the compute resources.
Clause 47. The method of clause 42 or any previous clause, wherein the chosen compute resource buyer is determined by the compute resource buyer selecting an option or by an automated selection by the compute exchange based on one or more parameters.
Clause 48. The method of clause 42 or any previous clause, wherein the compute exchange receives characteristics of the compute resources from the group of compute resource sellers that would be offered at real-time pricing, wherein the chosen compute resource buyer is determined based on the price being a lowest-price for the real-time pricing or characteristics of the compute resources from the compute resource seller even when the compute resources are not lowest-priced compute resources.
Clause 49. The method of clause 42 or any previous clause, wherein the chosen compute resource buyer is determined based on real-time status data about an on-premises compute environment associated with the compute resource buyer.
Clause 50. The method of clause 42 or any previous clause, wherein the compute exchange comprises: a workload manager, a high-performance computing suite, an on-demand data center engine and one or more applications available for the compute resource buyer.
Clause 51. The method of clause 42 or any previous clause, wherein the portion of the workload comprises less than a full amount of the workload.
Clause 52. The method of clause 42 or any previous clause, wherein the compute resource buyer divides the workload into the portion of the workload and a second portion of the workload, and wherein the method further comprises: receiving the portion of the workload at the compute resource seller.
Clause 53. The method of clause 52 or any previous clause, wherein a second compute environment processes the second portion of the workload.
Clause 54. A system comprising: at least one processor; and a computer-readable storage device storing instructions which, when executed by the at least one processor, cause the at least one processor to be configured to: transmit, from the system which comprises a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.
Clause 55. A system comprising: means for transmitting, from a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; means for receiving a portion of the workload from the chosen compute resource buyer at the compute resource seller for processing on the purchased compute resources; and means for transmitting a result from processing the workload on the purchased compute resources of the chosen compute resource buyer.
Clause 56. A computer-readable storage device storing instructions which, when executed by at least one processor, cause the at least one processor to be configured to: transmit, from a compute resource seller of a group of compute resources sellers comprising one or more compute resource seller and to a compute exchange, a sell order to sell compute resources to process workload, wherein the compute exchange receives a buy order from a compute resource buyer from a plurality of compute resource buyers and matches the buy order from the compute resource buyer with the sell order from the one or more compute resource seller to identify a chosen compute resource buyer at a price to obtain purchased compute resources; receive a portion of the workload from the chosen compute resource buyer at the compute resource seller for processing on the purchased compute resources; and transmit a result from processing the workload on the purchased compute resources of the chosen compute resource buyer.
Clause 57. A method or system of any previous clause, wherein the compute resources comprise one or more of a software application, an artificial intelligence application, a machine learning application, hardware, bandwidth, communication pathways, blockchain-based services and virtual compute resources.
Clause 58 A method comprising: receiving, at a compute exchange, a buy order from a compute resource buyer of a plurality of compute resource buyers to purchase compute resources to process workload; receiving, at the compute exchange and at a first time, a sell order from a compute resource seller to sell compute resources at a future time relative to the first time; matching, at the compute exchange, the buy order from the compute resource buyer with the sell order from the compute resource seller to yield a transaction; and causing the transaction to be recorded.
Clause 59. The method of Clause 58, further comprising: when the future time becomes a current time, initiating, by the compute exchange, a process to enable a portion of the workload from the compute resource buyer to be processed by the compute resources from the compute resource seller at a price.
Clause 60. The method of Clause 59 or any previous clause, further comprising: causing the transaction to be recorded on a blockchain network comprising a plurality of distributed nodes operating a distributed ledger and consensus algorithm, wherein a block is added to a blockchain of the blockchain network to record the transaction in an immutable manner.
Clause 61. The method of Clause 60 or any previous clause, wherein the compute resource seller is one of a plurality of compute resource sellers.
Clause 62. The method of Clause 58 or any previous clause, wherein a price for the compute resources is based on one or more of the buy order, the sell order, availability of access to the compute resources of the compute resource seller at the future time, a characteristic of the workload, and characteristics of the compute resources at the compute resource seller.
Clause 63. The method of Clause 58 or any previous clause, wherein a price for the compute resources is based on respective real-time pricing of respective cloud compute resources from the compute resource seller based on a current demand for the respective cloud compute resources at the first time or the future time.
Clause 64. The method of Clause 58 or any previous clause, further comprising: receiving characteristics of the compute resource seller that would be offered at real-time pricing, wherein the compute resource seller is determined from a group of compute resources sellers based on a price being a lowest-price for the real-time pricing or characteristics of the compute resources from the compute resource seller even when the compute resources are not lowest-priced compute resources.
Clause 65. The method of Clause 58 or any previous clause, wherein the compute exchange comprises: a workload manager, a high-performance computing suite, an on-demand data center engine, one or more applications available for the compute resource buyer, a blockchain-based smart contract and a blockchain interface for communicating transitions to a blockchain network.
Clause 66. The method of Clause 59 or any previous clause, further comprising: causing, by the compute exchange, a deployment of a second portion of the workload on an on-premises compute environment of the compute resource buyer.
Clause 67. The method of Clause 58 or any previous clause, further comprising: causing, via the compute exchange, a division of the workload into a first portion of the workload and a second portion of the workload; and causing, via the compute exchange, a deployment of the first portion of the workload on the compute resources at the future time at the compute resource seller and a deployment of the second portion of the workload on a second compute environment.
Clause 68. The method of Clause 67 or any previous clause, wherein the second compute environment comprises an on-premises compute environment of the compute resource buyer.
Clause 69. The method of Clause 67 or any previous clause, wherein the second compute environment comprises second compute resources at the compute resource seller at a different time than the future time.
Clause 70. The method of Clause 58 or any previous clause, further comprising: handling, via the compute exchange, a secondary sale of the compute resources from the buyer to a second buyer before the future time becomes a current time.
Clause 71. The method of Clause 70 or any previous clause, wherein a transaction is recorded on a blockchain network confirming the buyer owns the compute resources for use at the future time, and a second transaction is recorded on the blockchain network when the buyer sells the compute resources to the second buyer.
Clause 72. A system comprising: at least one processor; and a computer-readable storage device storing instructions which, when executed by the at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.
Clause 73. The system of Clause 72, wherein the computer-readable storage device stores instructions which, when executed by the at least one processor, cause the at least one processor to be configured to: when the future time becomes a current time, initiate, by the compute exchange, a process to enable a portion of the workload from the compute resource buyer to be processed by the compute resources from the compute resource seller at a price.
Clause 74. The system of Clause 73 or any previous clause, wherein the computer-readable storage device stores instructions which, when executed by the at least one processor, cause the at least one processor to be configured to: cause the transaction to be recorded on a blockchain network comprising a plurality of distributed nodes operating a distributed ledger and consensus algorithm, wherein a block is added to a blockchain of the blockchain network to record the transaction in an immutable manner.
Clause 75. A system comprising: means for receiving, at a compute exchange, a buy order from a compute resource buyer of a plurality of compute resource buyers to purchase compute resources to process workload; means for receiving, at the compute exchange and at a first time, a sell order from a compute resource seller to sell compute resources at a future time relative to the first time; means for matching, at the compute exchange, the buy order from the compute resource buyer with the sell order from the compute resource seller to yield a transaction; and means for causing the transaction to be recorded.
Clause 76. The system of Clause 75, further comprising: means for, when the future time becomes a current time, initiating, by the compute exchange, a process to enable a portion of the workload from the compute resource buyer to be processed by the compute resources from the compute resource seller at a price.
Clause 77. The system of Clause 76 or any previous clause, further comprising: means for causing the transaction to be recorded on a blockchain network comprising a plurality of distributed nodes operating a distributed ledger and consensus algorithm, wherein a block is added to a blockchain of the blockchain network to record the transaction in an immutable manner.
Clause 78. A computer-readable storage device storing instructions which, when executed by at least one processor, cause the at least one processor to be configured to: receive, at a compute exchange, a buy order from a compute resource buyer of a plurality of compute resource buyers to purchase compute resources to process workload; receive, at the compute exchange and at a first time, a sell order from a compute resource seller to sell compute resources at a future time relative to the first time; match, at the compute exchange, the buy order from the compute resource buyer with the sell order from the compute resource seller to yield a transaction; and cause the transaction to be recorded.
Clause 79. The computer-readable storage device storing instructions of Clause 78 which store further instructions, when executed by at least one processor, that cause the at least one processor to be configured to: when the future time becomes a current time, initiate, by the compute exchange, a process to enable a portion of the workload from the compute resource buyer to be processed by the compute resources from the compute resource seller at a price.
Clause 80. The computer-readable storage device storing instructions of Clause 79 or any previous clause, which store further instructions, when executed by at least one processor, that cause the at least one processor to be configured to: cause the transaction to be recorded on a blockchain network comprising a plurality of distributed nodes operating a distributed ledger and consensus algorithm, wherein a block is added to a blockchain of the blockchain network to record the transaction in an immutable manner.

What is claimed is:

1. A method comprising:
receiving, at a compute exchange, a buy order from a compute resource buyer of a plurality of compute resource buyers to purchase compute resources to process workload;
receiving, at the compute exchange, a sell order from one or more compute resource seller from a plurality of compute resource sellers;
matching, at the compute exchange, the buy order from the compute resource buyer with the sell order from the one or more compute resource seller to identify a chosen compute resource seller at a price; and
initiating, by the compute exchange, a process to enable a portion of the workload from the compute resource buyer to be processed by the compute resources from the chosen compute resource seller at the price.

2. The method of claim 1, further comprising:
receiving a registration of respective buyer accounts at the compute exchange from the plurality of compute resource buyers; and
receiving a registration of respective seller accounts at the compute exchange from the plurality of compute resource sellers.

3. The method of claim 2, wherein each compute resource seller of the plurality of compute resource sellers is a cloud service provider.

4. The method of claim 1, wherein the price is based on one or more of the buy order, the sell order, availability of access to the compute resources of the one or more compute resource seller, a characteristic of the workload, and characteristics of the compute resources at the chosen compute resource seller.

5. The method of claim 1, wherein the price is further based on respective real-time pricing of respective cloud compute resources from the plurality of compute resource sellers based on a current demand for the respective cloud compute resources.

6. The method of claim 1, wherein determining the chosen compute resource seller occurs by a user selection or an automated selection by the compute exchange based on one or more parameters.

7. The method of claim 1, further comprising:
receiving characteristics of the compute resources from the plurality of compute resource sellers that would be offered at real-time pricing, wherein the chosen compute resource seller is determined based on the price being a lowest-price for the real-time pricing or characteristics of the compute resources from the chosen compute resource seller even when the compute resources are not lowest-priced compute resources.

8. The method of claim 1, further comprising:
determining the chosen compute resource seller based on real-time status data about an on-premises compute environment associated with the compute resource buyer.

9. The method of claim 1, wherein the compute exchange comprises: a workload manager, a high-performance computing suite, an on-demand data center engine and one or more applications available for the compute resource buyer.

10. The method of claim 1, further comprising:
causing, by the compute exchange, a deployment of a second portion of the workload on an on-premises compute environment of the compute resource buyer.

11. The method of claim 1, further comprising:
causing, via the compute exchange, a division of the workload into the portion of the workload and a second portion of the workload; and
causing, via the compute exchange, a deployment of the portion of the workload on the chosen compute resource seller and a deployment of the second portion of the workload on a second compute environment.

12. The method of claim 11, wherein the second compute environment comprises an on-premises compute environment of the compute resource buyer.

13. A system for operating a compute exchange, the system comprising:
at least one processor; and
a computer-readable storage device storing instructions which, when executed by the at least one processor, cause the at least one processor to be configured to:
receive, at a compute exchange, a buy order from a compute resource buyer of a plurality of compute resource buyers to purchase compute resources to process workload;
receive, at the compute exchange, a sell order from one or more compute resource seller from a plurality of compute resource sellers;
match, at the compute exchange, the buy order from the compute resource buyer with the sell order from the one or more compute resource seller to identify a chosen compute resource seller at a price; and
initiate, by the compute exchange, a process to enable a portion of the workload from the compute resource buyer to be processed by the compute resources from the chosen compute resource seller at the price.

14. The system of claim 13, wherein the computer-readable storage device stores instructions which, when executed by the at least one processor, cause the at least one processor to be configured to:
receive a registration of respective buyer accounts at the compute exchange from the plurality of compute resource buyers; and
receive a registration of respective seller accounts at the compute exchange from the plurality of compute resource sellers.

15. The system of claim 14, wherein each compute resource seller of the plurality of compute resource sellers is a cloud service provider.

16. The system of claim 13, wherein the price is based on one or more of the buy order, the sell order, availability of access to the compute resources of the one or more compute resource seller, a characteristic of the workload, and characteristics of the compute resources at the chosen compute resource seller.

17. The system of claim 13, wherein the price is further based on respective real-time pricing of respective cloud compute resources from the plurality of compute resource sellers based on a current demand for respective cloud compute resources and wherein determining the chosen compute resource seller occurs by a user selection or an automated selection by the compute exchange based on one or more parameters.

18. The system of claim 13, wherein the computer-readable storage device stores instructions which, when executed by the at least one processor, cause the at least one processor to be configured to:
receive characteristics of the compute resources from the plurality of compute resource sellers that would be offered at real-time pricing, wherein the chosen compute resource seller is determined based on the price being a lowest-price for the real-time pricing or characteristics of the compute resources from the chosen compute resource seller even when the compute resources are not lowest-priced compute resources; and
determine the chosen compute resource seller based on real-time status data about an on-premises compute environment associated with the compute resource buyer.

19. A computer-readable storage device storing instructions which, when executed by at least one processor, cause the at least one processor to be configured to:
receive, at a compute exchange, a buy order from a compute resource buyer of a plurality of compute resource buyers to purchase compute resources to process workload;
receive, at the compute exchange, a sell order from one or more compute resource seller from a plurality of compute resource sellers;
match, at the compute exchange, the buy order from the compute resource buyer with the sell order from the one or more compute resource seller to identify a chosen compute resource seller at a price; and
initiate, by the compute exchange, a process to enable a portion of the workload from the compute resource buyer to be processed by the compute resources from the chosen compute resource seller at the price.
